(19) United States
(12) Patent Application Publication
(10) Pub. No.: US 2019/0394188 A1
(43) Pub. Date: Dec. 26, 2019

(54) INFORMATION PROCESSING APPARATUS, INFORMATION PROCESSING METHOD, AND AUTHENTICATION LINKING SYSTEM

(71) Applicant: SHARP KABUSHIKI KAISHA, Sakai City (JP)

(72) Inventor: HIROTAKA KODAMA, Sakai City (JP)

(21) Appl. No.: 16/446,322

(22) Filed: Jun. 19, 2019

(30) Foreign Application Priority Data
Jun. 25, 2018 (JP) 2018-120114

(51) Int. Cl. H04L 29/06; G06F 21/41; H04L 29/08; H04N 1/44

(52) U.S. Cl. CPC H04L 63/0815; H04L 63/083; H04N 1/4426; H04L 67/16; H04N 1/4413; G06F 21/41

(57) ABSTRACT

An information processing apparatus capable of easily constructing an environment in which user authentication is performed in a linking manner is provided. The information processing apparatus includes an authentication portion which performs user authentication based on internal user information entered by a login operation on the information processing apparatus, an authentication link information holding portion which stores, if external user information to be entered to use a service provided via a network matches the internal user information, authentication link information including the internal user information, and an authentication link control portion which performs control, if the authentication link information is stored in the authentication link information holding portion, to permit a user who logs into the information processing apparatus with the internal user information to use the service.

### BACKGROUND OF THE INVENTION

### Field of the Invention

The present invention relates to an information processing apparatus which performs user authentication of a user, an information processing method, and an authentication linking system.

### Description of the Background Art

In recent years, a cloud service (Infrastructure as Service: IaaS), which provides computing resources such as storage in a server apparatus to an information terminal, which serves as a client, via a communication network such as the Internet, has been used.

In order to use the cloud service, generally, user authentication for identifying the user is necessary. For example, when a cloud service is to be used from an information terminal, it is necessary to enter user authentication information in each of the information terminal and the cloud service.

In contrast, a system which realizes what is called “single sign-on” of logging into an information terminal and a cloud service by only a single login operation by linking of the user authentication information, is disclosed (for example, see Patent Literature 1: Japanese Unexamined Patent Application Publication No. 20113-8140).

However, an authentication server which links with the information terminal is needed in order to realize the single sign-on in the conventional technology. Consequently, this causes an environment in which the user authentication is to be performed in a linking manner to be complicated. For this reason, there has been a problem that it is difficult to introduce such technology.

The present invention has been made in view of the problems described above, and the object of the present invention is to provide an information processing apparatus, an information processing method, and an authentication linking system capable of easily constructing an environment in which the user authentication is performed in a linking manner.

### SUMMARY OF THE INVENTION

The information processing apparatus of the invention relates to an information processing apparatus which uses a service provided by a server connected to the information processing apparatus via a network, the information processing apparatus, comprising:

an authentication portion which performs user authentication on the basis of internal user information which is user information to be entered by a login operation on the information processing apparatus;

a determination portion which determines whether external user information which is user information to be entered to use the service, matches the internal user information;

an authentication link information holding portion which stores therein authentication link information including the user information determined to be matching by the determination portion; and

an authentication link control portion which performs control, if the authentication link information is stored in the authentication link information holding portion, to permit use of the service provided via the network for a user who logs into the information processing apparatus with the internal user information.

The information processing method of the invention relates to an information processing method in an information processing apparatus which uses a service provided by a server connected to the information processing apparatus via a network, the information processing method comprising:

performing user authentication on the basis of internal user information which is user information to be entered by a login operation on the information processing apparatus;

determining whether external user information which is user information to be entered to use the service, matches the internal user information;

storing authentication link information including the user information determined to be matching by the determining; and

performing control, if the authentication link information is stored, to permit use of the service provided via the network for a user who logs into the information processing apparatus with the internal user information.

The authentication linking system of the invention relates to an authentication linking system comprising an image forming apparatus which uses a service provided by a server connected to the image forming apparatus via a network, the image forming apparatus comprising:

an authentication portion which performs user authentication on the basis of internal user information which is user information to be entered by a login operation on the image forming apparatus;

a determination portion which determines whether external user information which is user information to be entered to use the service, matches the internal user information;

an authentication link information holding portion which stores therein authentication link information including the user information determined to be matching by the determination portion; and

an authentication link control portion which performs control, if the authentication link information is stored in the authentication link information holding portion, to permit use of the service provided via the network for a user who logs into the image forming apparatus with the internal user information.

According to the information processing apparatus and the like of the invention, linking of the user authentication in the information terminal and the cloud service can be performed with a simple configuration.

### BRIEF DESCRIPTION OF THE DRAWINGS

FIG. 1 is a schematic view of an authentication linking system according to a first embodiment.

FIG. 2 is a functional configuration diagram of the authentication linking system according to the first embodiment.

FIG. 3 is a view showing an example of an operation screen displayed on a display screen.

FIG. 4 is a table showing an example of authentication link information stored in a storage portion.

FIG. 5 is a flowchart showing a flow of processing to be carried out until a user logs into an image forming apparatus.

FIG. 6 is a flowchart showing a flow of processing to be carried out until the authentication link information is stored in a storage portion.

FIG. 7 is a flowchart showing a flow of processing to be carried out a user logs into a cloud service.

FIG. 8 is a schematic view of an authentication linking system according to a second embodiment.

FIG. 9 is a table showing an example of authentication link information in the second embodiment.

FIG. 10 is a view showing an example of a cloud service selection. screen in the second embodiment.

FIG. 11 is a table showing an example of authentication link information in a third embodiment.

### DESCRIPTION OF THE PREFERRED EMBODIMENTS

Hereinafter, exemplified embodiments for carrying out the invention will be explained with reference to the drawings. In the exemplified embodiments, as an example, a case where an information processing apparatus of the invention is applied to an image forming apparatus as a multifunction machine (multifunction peripheral) in which the capabilities of a printer, a copier, a facsimile machine etc., are integrated will be described.

### 1. First Embodiment

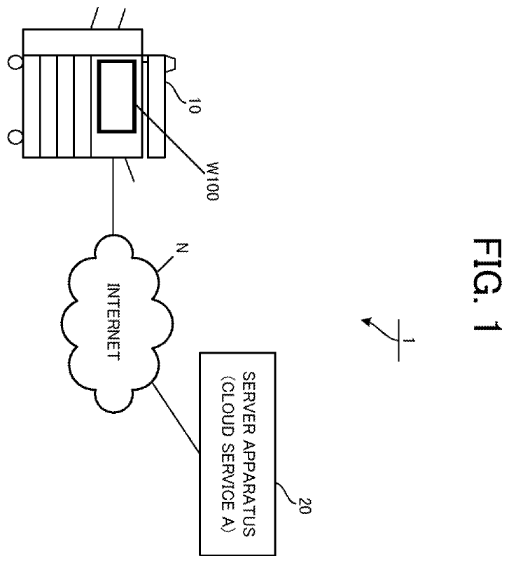

First, the structure of an authentication linking system 1 according to an embodiment of the invention will be described referring to FIGS. 1, 2, 3 and 4.

FIG. 1 is a view showing an outline of the authentication linking system 1 according to a first embodiment of the invention. In FIG. 1, the authentication linking system 1 includes an image forming apparatus 10 used by a user, and a server apparatus 20. The image forming apparatus 10 and the server apparatus 20 are communicably connected to each other via a network N. The network N is, for example, the Internet.

The image forming apparatus 10 includes a central processing unit (CPU) and a storage medium, and also has the function of a computer including a communication function. The image forming apparatus 10 is, for example, a multifunction apparatus as a multifunction machine in which the capabilities of a printer, a copier, a facsimile machine, and the like, are integrated.

The server apparatus 20 is a server computer that provides a cloud service A via the Internet. As the cloud service A, for example, the server apparatus 20 accepts uploading or downloading of file data from a client, and provides a storage service of performing file management. Note that the server apparatus 20 may include a server group comprised of a plurality of server devices, and may be a server which uses the server group to construct a virtual machine and manages the virtual machine.

The image forming apparatus 10 includes a display screen W100. The display screen W100 is, for example, a touch screen in which a liquid crystal panel or an organic EL panel and a touch panel are integrated. On the display screen W100, a key input area for inputting a key by a touch operation is displayed at a part of a display area. A key input on the display screen W100 is an input operation of characters, numbers, symbols, and the like, performed by the user with a software keyboard displayed on the display screen W100.

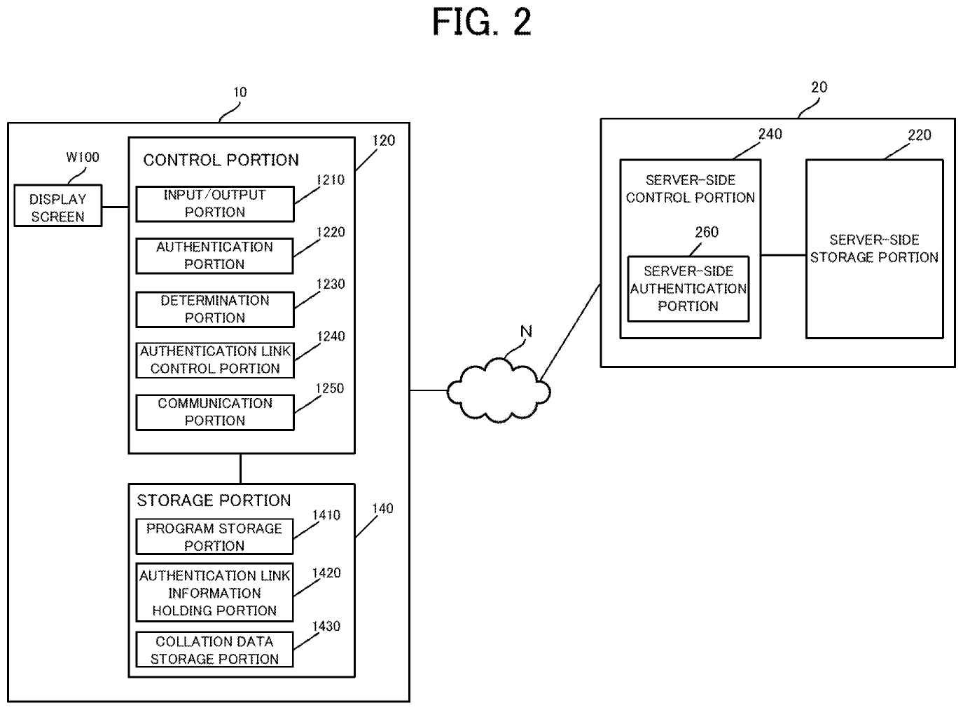

Next, the image forming apparatus 10 and the server apparatus 20 constituting the authentication linking system 1 will be described in detail with reference to the functional configuration diagram shown in FIG. 2.

FIG. 2 is a functional configuration diagram of the authentication linking system 1 according to the first embodiment. First, the image forming apparatus 10 will be described. The image forming apparatus 10 includes a control portion 120 and a storage portion 140.

The control portion 120 is configured by, for example, a CPU. The control portion 120 executes various programs stored in advance in the storage portion 140, thereby collectively controlling the functions of the image forming apparatus 10. The control portion 120 includes an input/output portion 1210, an authentication portion 1220, a determination portion 1230, an authentication link control portion 1240, and a communication portion 1250.

The input/output portion 1210 controls the screen displayed on the display screen W100. For example, when a login to the image forming apparatus 10 by the user is successful, the input/output portion 1210 displays an operation screen of the image forming apparatus 10 on the display screen W100.

The input/output portion 1210 receives a key input from the display screen W100. For example, the input/output portion 1210 acquires internal user information which is the user authentication information for a login to the image forming apparatus 10, and sends the acquired internal user information to the authentication portion 1220. Further, as external user information which is the user authentication information for a login to the cloud service, is acquired from the display screen W100, the input/output portion 1210 transmits the external user information to the determination portion 1230.

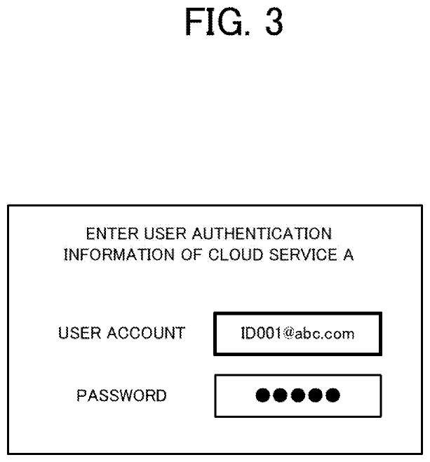

FIG. 3 is a view showing an example of the operation screen displayed on the display screen W100. For example, when the external user information is entered by the user through an operation screen for entering the user authentication information (the external user information) of the cloud service A as shown in FIG. 3, the input/output portion 1210 acquires a user account and a password as the entered external user information.

In accordance with the internal user information being transmitted, the authentication portion 1220 performs a user authentication (hereinafter referred to as “local user authentication”) in the image forming apparatus 10 on the basis of the internal user information. The internal user information is constituted of, for example, a user account and a password.

As the local user authentication, specifically, the authentication portion 1220 collates the internal user information with collation data stored in the storage portion 140. The internal user information is constituted of, for example, a user account and a password. The internal user information may be, for example, voice data for voiceprint authentication, image data for fingerprint authentication or face authentication, and the like. The authentication portion 1220 notifies the determination portion 1230 of the internal user information successfully authenticated in the local user authentication.

The determination portion 1230 determines whether the internal user information sent from the authentication portion 1220 matches the external user information transmitted via the input/output portion 1210. Note that the determination portion 1230 may make determination of whether the internal user information matches the external user information at the point when the external user information is transmitted from the input/output portion 1210. Further, the determination portion 1230 may make determination of whether the internal user information matches the external user information after the image forming apparatus 10 permits to access the cloud service.

The authentication link control portion 1240 generates authentication link information including the external user information or the internal user information (referred to as “link user authentication information”) determined to be matching by the determination portion 1230, and stores the generated authentication link information in the storage portion 140. Note that the authentication link information may include information indicating the date and time this authentication link information was generated.

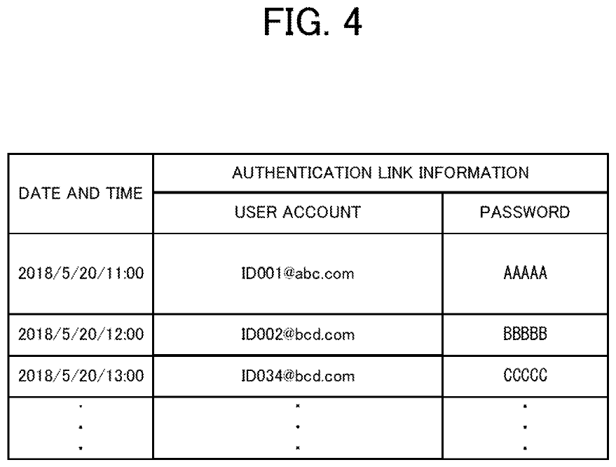

FIG. 4 is a table showing an example of the authentication link information stored in the storage portion 140. As shown in FIG. 4, for example, the authentication link information includes the user account “ID001@abc.com” and the password “AAAAA” as the link user authentication information, and the information “2018/5/20/11:00” indicating the date and time when the authentication link information is generated. Although the case where the user account is represented by an e-mail address is illustrated as an example in the present embodiment, the invention is not limited to the above. Here, an e-mail address includes a local part (for example, “ID 001”) corresponding to a part before an at mark (“@”) of the address, and a domain (for example, “abc.com”) corresponding to a part after the at mark (“@”) of the address. The user may, for example, enter only the local part of the user account at the login operation, and select and specify the domain which is set in advance. Alternatively, the user may enter only the local part of the user account at the login operation, and the domain set in advance may be automatically complemented.

In accordance with access request for the cloud service made by the user, the authentication link control portion 1240 determines whether the authentication link information including the external user information for the cloud service (more specifically, the link user authentication information) is stored in the storage portion 140.

For example, when the authentication link information of the user who made the access request for the cloud service is not stored in the storage portion 140, the authentication link control portion 1240 transmits the access request for the cloud service to the server apparatus 20.

The authentication link control portion 1240 executes control to allow the user to use the cloud service when the authentication link information of the user who requests access to the cloud service is stored in the storage portion 140. In other words, when the authentication link information is stored inn the storage portion 140, the authentication link control portion 1240 performs a login operation for the cloud service without requesting the user corresponding to the authentication link information to enter the external user information.

That is, when the cloud service is accessed by the user, the authentication link control portion 1240 refers to the authentication link information stored in the storage portion 140. For example, when an access request for the cloud service A is made from the user, the authentication link control portion 1240 refers to the authentication link information stored in the storage portion 140. Further, if the authentication link information corresponding to the cloud service A is stored in the storage portion 140, the authentication link control portion 1240 sends a login request to the server apparatus 20.

The authentication link control portion 1240 may be set to perform a login operation for the cloud service corresponding to the authentication link information, for a predetermined period set in advance, based on the date and time included in the authentication link information. In this case, for example, if an access request for the cloud service is made within a set period, a login operation for the cloud service is performed without requesting the user to enter the external user information.

On the other hand, if an access request for the cloud service is made out of the set period, the user is requested to enter the external user information. Consequently, security related to access to the cloud service can be effectively enhanced.

The communication portion 1250 transmits and receives data to and from the server apparatus 20 via the network N. For example, the communication portion 1250 transmits an access request for the cloud service A and a user authentication request to the server apparatus 20 on the basis of control of the authentication link control portion 1240.

Next, the storage portion 140 will be described. The storage portion 140 is configured by, for example, a ROM, a RAM, a hard disk, and the like. The storage portion 140 includes a program storage portion 1410, an authentication link information holding portion 1420, and a collation data storage portion 1430.

The program storage portion 1410 stores various programs for causing the control portion 120 of the image forming apparatus 10 to function as the input/output portion 1210, the authentication portion 1220, the determination portion 1230, the authentication link control portion 1240, and the communication portion 1250.

The authentication link information holding portion 1420 is configured by, for example, a cache memory, a RAM, and the like. More specifically, the authentication link information holding portion 1420 is a memory device for which the speed of access by the CPU is higher than that of a secondary storage device such as a hard disk. In the authentication link information holding portion 1420, authentication link information is stored by the control of the authentication link control portion 1240.

In the collation data storage portion 1430, collation data which is the user information of a user who is permitted to log into the image forming apparatus 10 is stored. The collation data is, for example, a user account and a password.

### Server Apparatus 20

Next, returning to FIG. 2, the server apparatus 20 will be described. The server apparatus 20 includes a server-side storage portion 220, a server-side control portion 240, and a server-side authentication portion 260.

The server-side storage portion 220 is configured by, for example, a ROM, a RAM, and a hard disk. The server-side storage portion 220 stores various programs for causing the server-side control portion 240 and the server-side authentication portion 260 of the server apparatus 20 to function.

The server-side control portion 240 includes, for example, a central processing unit (CPU). The server-side control portion 240 provides the cloud service A by executing various programs stored in advance in the server-side storage portion 220 to collectively control the functions related to the server apparatus 20.

The server-side control portion 240 comprises the server-side authentication portion 260 which performs collation (hereinafter referred to as “external user authentication”) of external user information included in an access request for the cloud service A with the user information for authentication stored in the server-side storage portion 220, in accordance with the access request transmitted from the image forming apparatus 10. The server-side authentication portion 260 transmits, to the image forming apparatus 10, the external user information successfully authenticated in the external user authentication. The external user information is, for example, user information including a user account and a password.

### Login Operation on Image Forming Apparatus 10

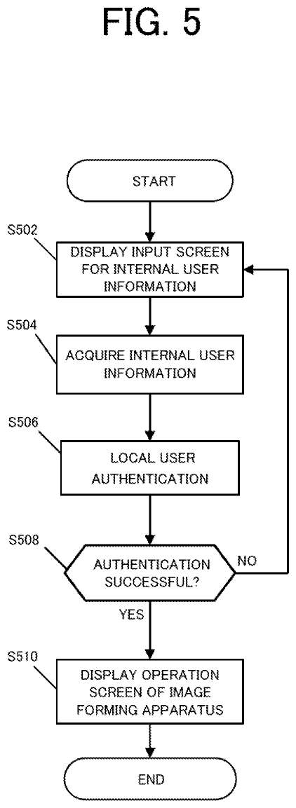

Next, a login operation for the image forming apparatus 10 by the user will be described. FIG. 5 is a flowchart showing a flow of processing carried out until the user logs into the image forming apparatus 10 in the authentication linking system 1 according to the first embodiment.

First, the input/output portion 1210 of the image forming apparatus 10 displays a screen for entering internal user information on the display screen W100 (step S502). Next, the authentication portion 1220 acquires the internal user information entered through the display screen W100 (step S504).

Next, the authentication portion 1220 performs the local user authentication based on the internal user information entered by the user (step S506).

Next, if the local user authentication is successful (YES in step S508), the input/output portion 1210 displays an operation screen of the image forming apparatus 10 on the display screen W100 (step S510).

Meanwhile, if the internal user information entered by the user does not match the collation data stored in the collation data storage portion 1430 (NO in step S508), the input/output portion 1210 displays on the display screen W100 a message indicating that the local user authentication failed, and thereafter displays the screen for entering the internal user information again on the display screen W100 (back to S502).

### Process of Storing Authentication Link Information

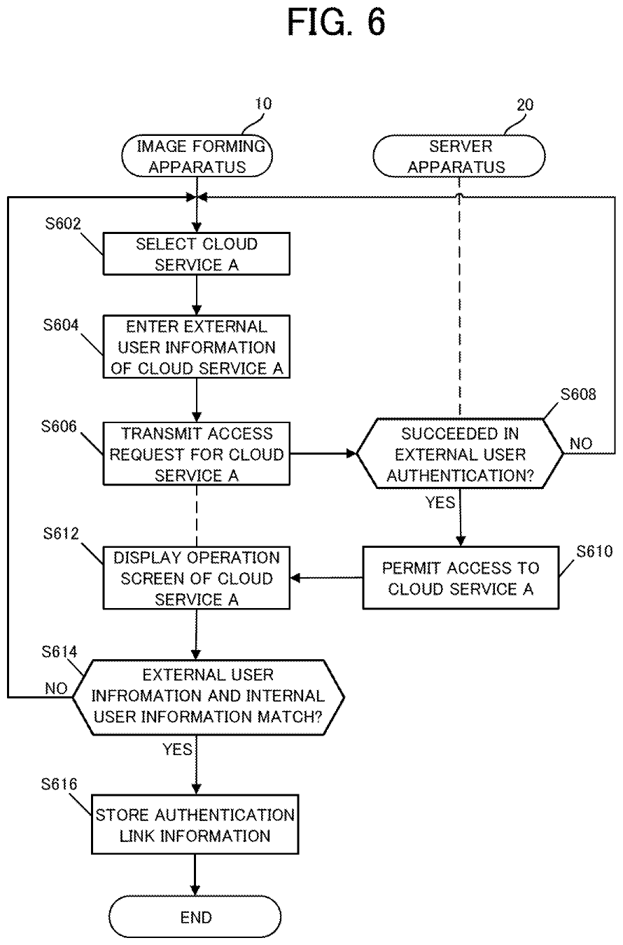

Next, a flow of processing carried out until the authentication link information in the image forming apparatus 10 is stored (cached) will be described. FIG. 6 is a flowchart showing the flow of processing carried out until the authentication link information is stored in the authentication link information holding portion 1420 of the image forming apparatus 10 according to the first embodiment.

First, the user selects and specifies the cloud service A on the display screen W100 of the image forming apparatus 10 (step S602). Here, it is assumed that the authentication link information is not stored in the authentication link information holding portion 1420.

Next, the input/output portion 1210 displays a screen for entering the external user information for the cloud service A on the display screen W100. When the external user information of the cloud service A is entered by the user (step S604), the authentication link control portion 1240 transmits the access request for the cloud service A including the external user information to the server apparatus 20 (step S606).

Next, the server-side authentication portion 260 of the server apparatus 20 performs the external user authentication of the cloud service A, on the basis of the access request transmitted from the image forming apparatus 10 (step S608).

If the external user authentication is successful (YES in step S608), the server-side authentication portion 260 allows the user of the image forming apparatus 10 to access the cloud service A (step S610). Specifically, the server-side authentication portion 260 transmits, to the image forming apparatus 10, an authentication permission response corresponding to information indicating that access to the cloud service A is permitted, and an operation screen of the cloud service A.

Next, the input/output portion 1210 of the image forming apparatus 10 displays the operation screen of the cloud service A acquired via the communication portion 1250 on the display screen W100 (step S612). The image forming apparatus 10 is thereby enabled to have control over the cloud service A.

Next, the determination portion 1230 determines whether the external user information and the internal user information that is entered by the user of the image forming apparatus 10 match with each other (step S614).

If the external user information matches the internal user information (YES in step S614), the authentication link control portion 1240 causes the authentication link information holding portion 1420 to store the authentication link information (step S616).

### Operation Flow of Authentication Linking

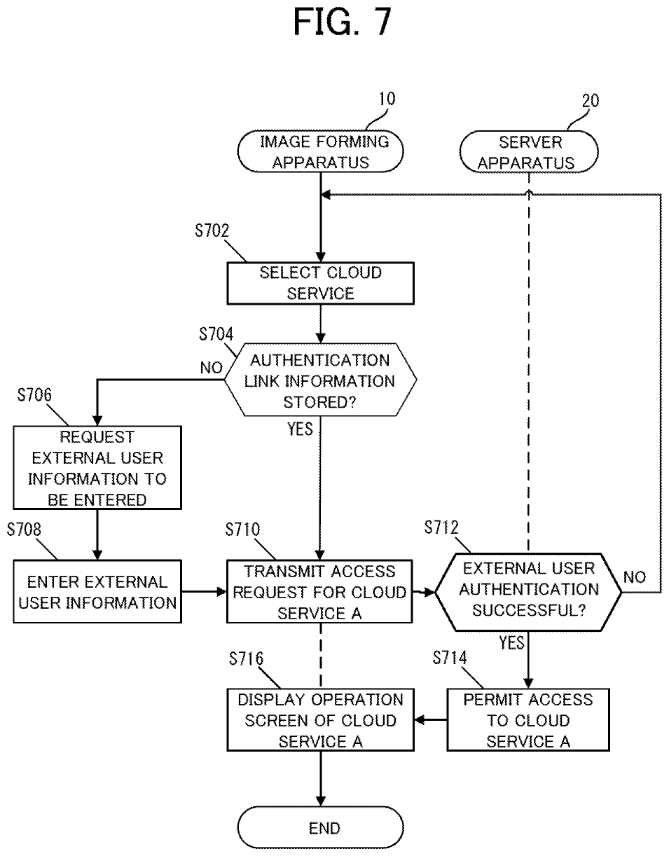

Next, a flow of processing carried out until the user logs into the cloud service A will be described. FIG. 7 is a flowchart showing the flow of processing carried out until the user logs into the cloud service A.

First, the user selects the cloud service A via the display screen W100 (step S702). Next, as the selection of the cloud service is accepted, the authentication link control portion 1240 determines whether the authentication link information of the user who selects the cloud service A is stored in the authentication link information holding portion 1420 (step S704).

When the authentication link information of the user is stored in the authentication link information holding portion 1420 (YES in step S704), the authentication link control portion 1240 transmits an access request for the cloud service A to the server apparatus 20 (step S710).

Next, the server-side authentication portion 260 of the server apparatus 20 performs the external user authentication, on the basis of the access request for the cloud service A (step S712).

Here, when the external user authentication of the cloud service A is successful (YES in step S712), the server-side authentication portion 260 transmits, to the image forming apparatus 10, an authentication response indicating that access to the cloud service A is permitted, and also an operation screen of the cloud service A (step S714).

Next, the input/output portion 1210 displays the operation screen of the cloud service A sent from the server apparatus 20 on the display screen W100 (step S716). As a result, a login to the cloud service A is completed, and the user is allowed to use the cloud service A via the operation screen of the image forming apparatus 10.

Note that if the authentication link information of the user is not stored in the authentication link information holding portion 1420 in the above step S704 (NO in step S704), the input/output portion 1210 displays a screen (not shown) for entry of the external user information of the cloud service A (step S706). When the user enters the external user information through the above-mentioned entry screen (step S708), the authentication link control portion 1240 transmits a request for authentication in the cloud service A to the server apparatus 20 (step S710).

Further, in the server apparatus 20, if the user authentication in the cloud service A fails in the above step S712 (NO in step S712), the server-side authentication portion 260 transmits an authentication failure response indicating login failure to the image forming apparatus 10. In accordance with the authentication failure response transmitted from the server apparatus 20, the input/output portion 1210 displays a message indicating that the user authentication in the cloud service A fails on the display screen W100, and thereafter displays again the cloud service selection screen (back to S702).

### Advantage of First Embodiment

As described above, according to the first embodiment, in a case where the internal user information for logging into the image forming apparatus 10 matches the external user information for logging into the cloud service A, the authentication link control portion 1240 stores the authentication link information in the authentication link information holding portion 1420.

Further, in a case where the authentication link information is stored in the authentication link information holding portion 1420 when the user uses the cloud service A, the authentication link control portion 1240 carries out a login process for the cloud service A without prompting the user to enter the login information. Consequently, once the user performs a login operation for the image forming apparatus 10, even if the cloud service A is to be used, the user can log into the cloud service A without being prompted to perform another login operation.

In other words, the authentication link information is stored in the authentication link information holding portion 1420 when the internal user information of the user of the image forming apparatus 10 matches the external user information. When the authentication link information is stored in the authentication link information holding portion 1420, the user of the image forming apparatus 10 can access and use the cloud service A speedily without being requested to perform the login operation for the cloud service A.

### 2. Second Embodiment

### Linking Authentication of Multiple Cloud Services

Next, a second embodiment will be explained. In the following, parts different from the first embodiment will be described. Explanation of the parts that are the same as those of the first embodiment is omitted as appropriate.

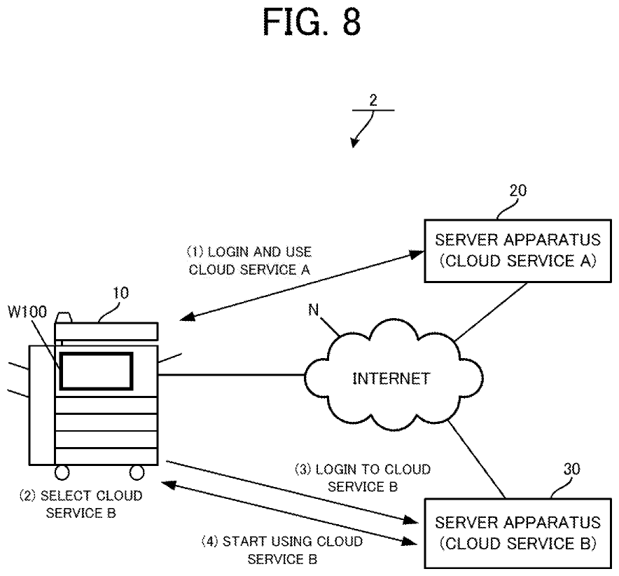

FIG. 8 is a schematic view of an authentication linking system 2 according to the second embodiment. In the authentication linking system 2, an image forming apparatus 10 is communicably connected to a server apparatus 20 and a server apparatus 30 via a network. N.

The second embodiment is distinguished from the first embodiment in that the second embodiment includes the server apparatus 30 which is connected to the network N to provide a cloud service B. The cloud service B provides, for example, an application which processes file data transmitted from a client via the network.

Here, a process of linking user authentication of a cloud service A and the cloud service B in the authentication linking system 2 will be outlined with reference to FIG. 8.

First, it is assumed that a user uses the cloud service A provided by the server apparatus 20 via the image forming apparatus 10 (see (1) in FIG. 8). Here, the cloud service B is selected by the user through a cloud service selection screen displayed on a display screen W100 (see (2) in FIG. 8). The image forming apparatus 10 makes a login request (access request) for the cloud service B to the server apparatus 30, in accordance with the instruction of selection by the user (see (3) in FIG. 8). Next, when the login to the cloud service B is permitted, the user of the image forming apparatus 10 can start using the cloud service B without being requested to enter the login information for the cloud service B (see (4) in FIG. 8).

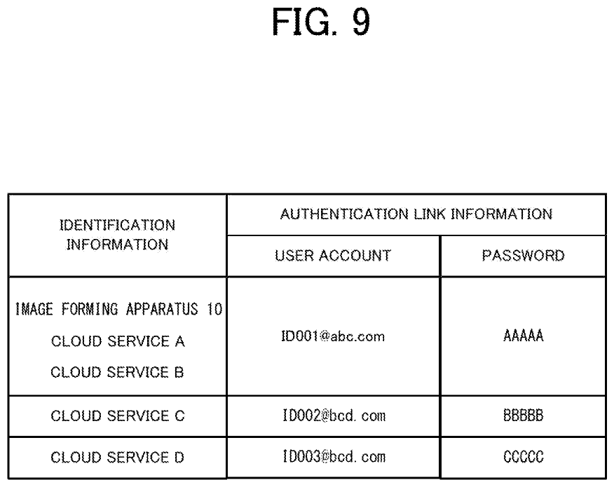

FIG. 9 is a table showing an example of authentication link information in the second embodiment. In the authentication link information in the second embodiment, for example, as shown inn FIG. 9, the external user information of each of the cloud services A and B and the internal user information (user login information) of the image forming apparatus 10 match with each other. In this case, as shown in FIG. 9, the authentication link control portion 1240 of the image forming apparatus 10 associates identification information and user login information of each of the cloud service A, the cloud service B, and the image forming apparatus 10 with each other, and stores the associated information in the authentication link information holding portion 1420.

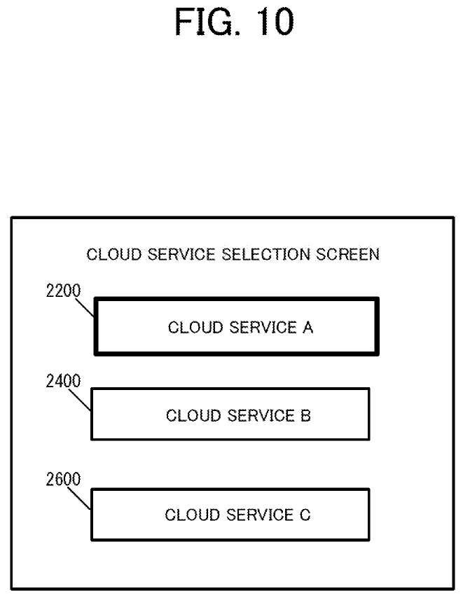

FIG. 10 is a view showing an example of the cloud service selection screen displayed on the display screen W100 in the second embodiment. FIG. 10 shows that a cloud service A 2200 is already selected and is being used, and shows the state in which a cloud service B 2400 and a cloud service C 2600 can be selected and specified.

The input/output portion 1210 of the image forming apparatus 10 displays the cloud service selection screen on the display screen W100 in response to a request from the user which is made via an operation screen.

For example, when the cloud service B 2400 is selected on the cloud service selection screen in FIG. 10, the authentication link control portion 1240 refers to the authentication link information in the authentication link information holding portion 1420. As shown in FIG. 9, since the user login information of the cloud service A currently being used and the user login information of the cloud service B that is selected and specified match with each other, the authentication link control portion 1240 transmits a request for authentication in the cloud service B to the server apparatus 30.

In other words, since the user login information (external user information) of the cloud service A matches that of the cloud service B, in the image forming apparatus 10, when the cloud service B is to be accessed, a login process for the cloud service B is carried out without requesting the user to enter the user login information of the cloud service B.

Subsequently, when a login to the cloud service B is completed, the input/output portion 1210 displays an operation screen for the cloud service B transmitted from the server apparatus 30 on the display screen W100. Consequently, the user is allowed to use the cloud service B.

### Advantage of Second Embodiment

As described above, according to the second embodiment, it is stored in the authentication link information that the user login information for logging into the cloud service A and the user login information for logging into the cloud service B match with each other. Here, when the user using the cloud service A wishes to use the cloud service B, the authentication link control portion 1240 carries out a login process for the cloud service B on the server apparatus 30, on the basis of the user login formation of the authentication link information, without prompting the user to enter the user login information (external user information) of the cloud service B.

As described above, in the second embodiment, the internal user information, which is the user login information for the image forming apparatus 10, also matches the user login information of each of the cloud services A and B. Thus, once the user performs a login operation for the image forming apparatus 10, the user can switch the use of the function as a multifunction machine of the image forming apparatus 10 currently being used and the cloud services A and B, without being requested for another login operation in using the cloud services A and B.

### 3. Third Embodiment

### Linking of Cloud Service A and Cloud Service B

Next, a third embodiment will be explained. In the third embodiment, while external user information of a cloud service A matches that of a cloud service B, the aforementioned external user information does not match internal user information, which is the user login information of an image forming apparatus 10. In this respect, the third embodiment is different from the second embodiment, but the two embodiments are the same in the other points.

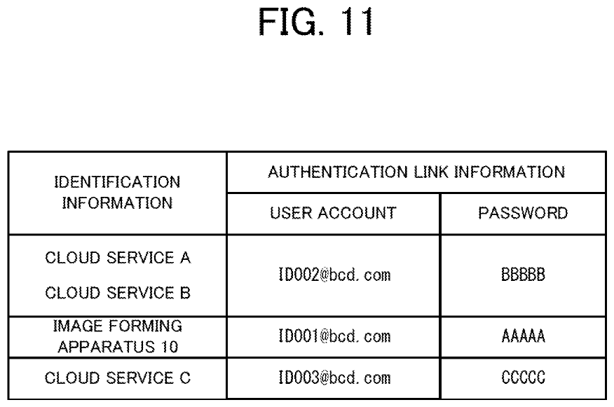

FIG. 11 is a table showing an example of authentication link information in the third embodiment. For example, as shown in FIG. 11, the authentication link information in the third embodiment indicates that the user login information (user account: ID002@bcd.com, password: BBBBB) for the cloud service A and that of the cloud service B match with each other. Meanwhile, FIG. 11 illustrates that the internal user information (user account: ID001@dcd.com, password: AAAAA), which is the user login information of the image forming apparatus 10 does not match the user login information (external user information) of the cloud services A and B.

For example, when a user using the cloud service A in the image forming apparatus 10 wishes to use the cloud service B, as in the second embodiment, an authentication link control portion 1240 in the third embodiment refers to the authentication link information in an authentication link information holding portion 1420, and transmits a request for authentication in the cloud service B to a server apparatus 30. Consequently, the authentication link control portion 1240 performs a login process for the cloud service B without prompting the user to enter the user login information (external user information) of the cloud service B.

On the other hand, in the third embodiment, for example, when a user who has logged in the image forming apparatus 10 locally wishes to use the cloud service B, the authentication link control portion 1240 executes control to prompt the user to enter user login information (external user information) of the cloud service B. In other words, a user is requested to enter user login information of a cloud service when the user who has locally logged in the image forming apparatus 10 accesses the cloud service via the image forming apparatus 10.

For example, a case where a guest user who is a visitor of a company uses the image forming apparatus 10 installed in the company by using a guest account and a guest password as the internal user information is considered. Here, it is assumed that the guest user uses, via the image forming apparatus 10, a plurality of cloud services for which the external user information is the same for all of the cloud services.

In this case, the guest user logs into the image forming apparatus 10 by using the guest account (ID001@bcd.com) and the guest password (AAAA). Since the guest account and the guest password do not match the user login information of each of the cloud services A and B, at the time of first login to each of the cloud services A and B via the image forming apparatus 10, the guest user is required to perform a login operation.

The authentication link information is thus stored in the image forming apparatus 10. Consequently, until the guest user of the image forming apparatus 10 logs out of the image forming apparatus 10, the guest user can thereafter use the cloud service without being requested to perform a login operation every time the use of the cloud services A and B is switched.

### Advantage of Third Embodiment

More specifically, according to the third embodiment, while the security related to user information regarding the image forming apparatus 10 installed in the company is effectively ensured, the user can use the cloud services without being requested for a login operation every time the cloud service being used is switched.

### 4. Modification Example

The invention is not limited to the embodiments described above, and various modifications can be made. That is, an embodiment obtained by combining technical means appropriately modified without departing from the spirit of the present invention is also included in the technical scope of the present invention.

Further, needless to say, apart from the embodiments explained, the embodiments described above may be appropriately combined and implemented within the scope which does not cause contradiction. For example, if the user changes his/her user login information in the image forming apparatus 10 or the cloud service, and the changed user login information matches the user login information of another cloud service used by the user, the authentication link control portion 1240 may store the aforementioned user login information in association with identification information of the cloud service with which the user login information matches in the authentication link information holding portion 1420. By doing so, the user can easily make the user login information of the image forming apparatus 10 and the cloud service common.

Furthermore, a program operating on each apparatus in the embodiments is a program for controlling a CPU or the like (i.e., a program for causing the computer to function) to realize the functions of the embodiments described above. Furthermore, information handled in such an apparatus as described above is temporarily accumulated in a temporary memory device (e.g., RAM) when being processed. Then, the information is stored in a memory device such as various read-only memories (ROMs) or a hard disk drive (HDD) and is read, modified, or written by the CPU, if necessary.

Here, as a recording medium for storing the program, any of a semiconductor medium (for example, a ROM, a non-volatile memory card, etc.), an optical recording medium/magneto-optical recording medium (for example, a digital versatile disc (DVD), a magneto optical disc (MO), a Mini Disc (MD), a compact disc (CD), a Blu-ray (registered trademark) disc, etc.), and a magnetic recording medium (for example, a magnetic tape, a flexible disk, etc.) may be employed. Moreover, not only the functions of the above-described embodiments are realized by execution of the loaded program, but also the functions of the present invention may be realized by processing carried out in cooperation with an operating system or other application programs, etc., based on the instructions of the program.

Furthermore, for distribution in the market, the program can be stored in a portable recording medium to be distributed, or transferred to a server computer connected via a network such as the Internet. In this case, needless to say, a memory device of the server computer is also included in the present invention.

What is claimed is:

1. An information processing apparatus which uses a service provided by a server connected to the information processing apparatus via a network, the information processing apparatus, comprising:
an authentication portion which performs user authentication on the basis of internal user information which is user information to be entered by a login operation on the information processing apparatus;
a determination portion which determines whether external user information which is user information to be entered to use the service, matches the internal user information;
an authentication link information holding portion which stores therein authentication link information including the user information determined to be matching by the determination portion; and
an authentication link control portion which performs control, if the authentication link information is stored in the authentication link information holding portion, to permit use of the service provided via the network for a user who logs into the information processing apparatus with the internal user information.

2. The information processing apparatus according to claim 1, wherein if the external user information corresponding to each of different services matches the internal user information included in the authentication link information stored in the authentication link information holding portion, the authentication link control portion does not request a login operation for each of the services when the user logging in the information processing apparatus with the internal user information uses the service.

3. The information processing apparatus according to claim 1, wherein if the internal user information of the user logging in the information processing apparatus does not match the external user information of the service, the authentication link control portion requests the user to enter the external user information when the user uses the service.

4. The information processing apparatus according to claim 1, wherein if the external user information corresponding to each of a plurality of the services different from each other is identical, the authentication link control portion causes the authentication link information holding portion to store therein identification information of each of the services.

5. The information processing apparatus according to claim 4, wherein if the identification information of the service is stored in the authentication link information holding portion, the authentication link control portion does not request a login operation for the service to the user when the user uses the service corresponding to the identification information.

6. The information processing apparatus according to claim 4, wherein if the identification information of the service is not stored in the authentication link information holding portion, the authentication link control portion requests a login operation for the service to the user when the user uses the service.

7. An information processing method in an information processing apparatus which uses a service provided by a server connected to the information processing apparatus via a network, the information processing method comprising:
performing user authentication on the basis of internal user information which is user information to be entered by a login operation on the information processing apparatus;
determining whether external user information which is user information to be entered to use the service, matches the internal user information;
storing authentication link information including the user information determined to be matching by the determining; and
performing control, if the authentication link information is stored, to permit use of the service provided via the network for a user who logs into the information processing apparatus with the internal user information.

8. An authentication linking system comprising an image forming apparatus which uses a service provided by a server connected to the image forming apparatus via a network, the image forming apparatus comprising:
an authentication portion which performs user authentication on the basis of internal user information which is user information to be entered by a login operation on the image forming apparatus;
a determination portion which determines whether external user information which is user information to be entered to use the service, matches the internal user information;
an authentication link information holding portion which stores therein authentication link information including the user information determined to be matching by the determination portion; and
an authentication link control portion which performs control, if the authentication link information is stored in the authentication link information holding portion, to permit use of the service provided via the network for a user who logs into the image forming apparatus with the internal user information.
